(19) United States
(12) Patent Application Publication
(10) Pub. No.: US 2024/0239406 A1
(43) Pub. Date: Jul. 18, 2024

(54) VEHICLE CONTROL DEVICE, VEHICLE CONTROL METHOD, AND STORAGE MEDIUM

(71) Applicant: TOYOTA JIDOSHA KABUSHIKI KAISHA, Toyota-shi (JP)

(72) Inventor: Kazuaki ASO, Gotemba-shi (JP)

(73) Assignee: TOYOTA JIDOSHA KABUSHIKI KAISHA, Toyota-shi (JP)

(21) Appl. No.: 18/501,306

(22) Filed: Nov. 3, 2023

(30) Foreign Application Priority Data
Jan. 12, 2023 (JP) 2023-002871

(51) Int. Cl. B62D 6/00

(52) U.S. Cl. CPC B62D 6/003

(57) ABSTRACT

The vehicle control device controls steering of the target vehicle. The vehicle control device sets a steering angle upper limit value, which is an upper limit value of the steering angle of the target vehicle that limits the lateral acceleration of the target vehicle to a predetermined lateral acceleration or less, based on the traveling state of the target vehicle, and controls the steering of the target vehicle so that the steering angle of the target vehicle becomes equal to or lower than the steering angle upper limit value.

### CROSS-REFERENCE TO RELATED APPLICATION

This application claims priority to Japanese Patent Application No. 2023-002871 filed on Jan. 12, 2023, incorporated herein by reference in its entirety.

### BACKGROUND

### 1. Technical Field

The present disclosure relates to a vehicle control device, a vehicle control method, and a storage medium for controlling steering of a vehicle.

### 2. Description of Related Art

As a vehicle control device for controlling steering of a vehicle, there is known a vehicle control device that restricts a steering angle of a vehicle to a predetermined steering angle or less to suppress a sudden change in the steering angle of the vehicle (see, for example, Japanese Unexamined Patent Application Publication No. 2019-59429 (JP 2019-59429 A)).

### SUMMARY

To ensure traveling safety of a vehicle, it is effective to restrict the steering angle of the vehicle to a predetermined steering angle or less when a request is made to restrict the lateral acceleration of the vehicle to a predetermined value or less. An upper limit value of the steering angle of the vehicle (steering angle upper limit value) for restricting the steering angle of the vehicle to the predetermined steering angle or less may be set based on a specification value of the vehicle or a steering angle zero point of the vehicle (a steering angle grasped as a steering angle that allows the vehicle to travel straightforward). However, the specification value of the vehicle varies depending on vehicles. Further, the steering angle zero point of the vehicle may deviate from the true steering angle zero point. Therefore, the steering angle upper limit value set based on the specification value of the vehicle or the steering angle zero point of the vehicle may be inappropriate for restricting the lateral acceleration of the vehicle to the predetermined value or less.

An object of the present disclosure is to provide a vehicle control device capable of setting an appropriate steering angle upper limit value for restricting the lateral acceleration of a vehicle to a predetermined value or less.

A vehicle control device according to the present disclosure includes a control device configured to control steering of a target vehicle. The control device is configured to: set, based on a traveling state of the target vehicle, a steering angle upper limit value that is an upper limit value of a steering angle of the target vehicle for restricting a lateral acceleration of the target vehicle to a predetermined lateral acceleration or less; and control the steering of the target vehicle to bring the steering angle of the target vehicle to the steering angle upper limit value or less.

As described above, to restrict the lateral acceleration of the vehicle to the predetermined value or less, the steering angle upper limit value may be set based on the specification value of the vehicle or the steering angle zero point of the vehicle (the steering angle grasped as the steering angle that allows the vehicle to travel straightforward). However, the specification value of the vehicle varies depending on vehicles. Further, the steering angle zero point of the vehicle may deviate from the true steering angle zero point. Therefore, the steering angle upper limit value set based on the specification value of the vehicle or the steering angle zero point of the vehicle may be inappropriate for restricting the lateral acceleration of the vehicle to the predetermined value or less.

According to the vehicle control device of the present disclosure, the steering angle upper limit value is set based on the traveling state of the target vehicle. The traveling state of the target vehicle is a state resulting from reflection of an actual specification value of the target vehicle or an actual steering angle zero point of the target vehicle. Therefore, the steering angle upper limit value set based on the traveling state of the target vehicle is appropriate for restricting the lateral acceleration of the target vehicle to the predetermined value or less. By restricting the steering angle of the target vehicle using the steering angle upper limit value set in this way, the lateral acceleration of the target vehicle can appropriately be restricted to the predetermined value or less.

In the vehicle control device according to the present disclosure, the traveling state may particularly be a detected value of a yaw rate of the target vehicle and a detected value of a traveling speed of the target vehicle.

The yaw rate of the vehicle is a value that changes depending on the steering angle of the vehicle and correlates with the lateral acceleration of the vehicle. The traveling speed of the vehicle is a value that affects the lateral acceleration of the vehicle.

In the vehicle control device according to the present disclosure, the steering angle upper limit value is set based on the yaw rate of the target vehicle and the traveling speed of the target vehicle. Therefore, the lateral acceleration of the target vehicle can appropriately be restricted to the predetermined value or less.

In the vehicle control device according to the present disclosure, the control device may be configured to: detect a yaw rate of the target vehicle and a traveling speed of the target vehicle as the traveling state; and set the steering angle upper limit value based on the yaw rate and the traveling speed without using the lateral acceleration of the target vehicle.

The lateral acceleration of the vehicle varies depending on the number of people in the vehicle, a lateral gradient of a road on which the vehicle is traveling, or the like even if the steering angle of the vehicle and the traveling speed of the vehicle are the same. The yaw rate of the vehicle is not affected by the number of people in the vehicle, the lateral gradient of the road on which the vehicle is traveling, or the like, and takes a constant value when the steering angle of the vehicle and the traveling speed of the vehicle are the same.

In the vehicle control device according to the present disclosure, the steering angle upper limit value is set based on the yaw rate of the target vehicle and the traveling speed of the target vehicle without using the lateral acceleration of the target vehicle. Therefore, the lateral acceleration of the target vehicle can appropriately be restricted to the predetermined value or less.

A vehicle control method according to the present disclosure is a method that controls steering of a target vehicle. The vehicle control method includes: a step of setting, based on a traveling state of the target vehicle, a steering angle upper limit value that is an upper limit value of a steering angle of the target vehicle for restricting a lateral acceleration of the target vehicle to a predetermined lateral acceleration or less; and a step of controlling the steering of the target vehicle to bring the steering angle of the target vehicle to the steering angle upper limit value or less.

With the vehicle control method according to the present disclosure, the lateral acceleration of the target vehicle can appropriately be restricted to the predetermined value or less for the same reason as described above.

A storage medium according to the present disclosure stores a vehicle control program that is a program that controls steering of a target vehicle. The vehicle control program is configured to:
set, based on a traveling state of the target vehicle, a steering angle upper limit value that is an upper limit value of a steering angle of the target vehicle for restricting a lateral acceleration of the target vehicle to a predetermined lateral acceleration or less; and
control the steering of the target vehicle to bring the steering angle of the target vehicle to the steering angle upper limit value or less.

With the vehicle control program according to the present disclosure, the lateral acceleration of the target vehicle can appropriately be restricted to the predetermined value or less for the same reason as described above.

The components of the present disclosure are not limited to the embodiment of the present disclosure described later with reference to the drawings. Other objects, other features, and accompanying advantages of the present disclosure will be readily understood from the description of the embodiment of the present disclosure.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram illustrating a vehicle control device according to an embodiment of the present disclosure; and

FIG. 2 is a flowchart illustrating a routine executed by the vehicle control device according to the embodiment of the present disclosure.

### DETAILED DESCRIPTION OF EMBODIMENTS

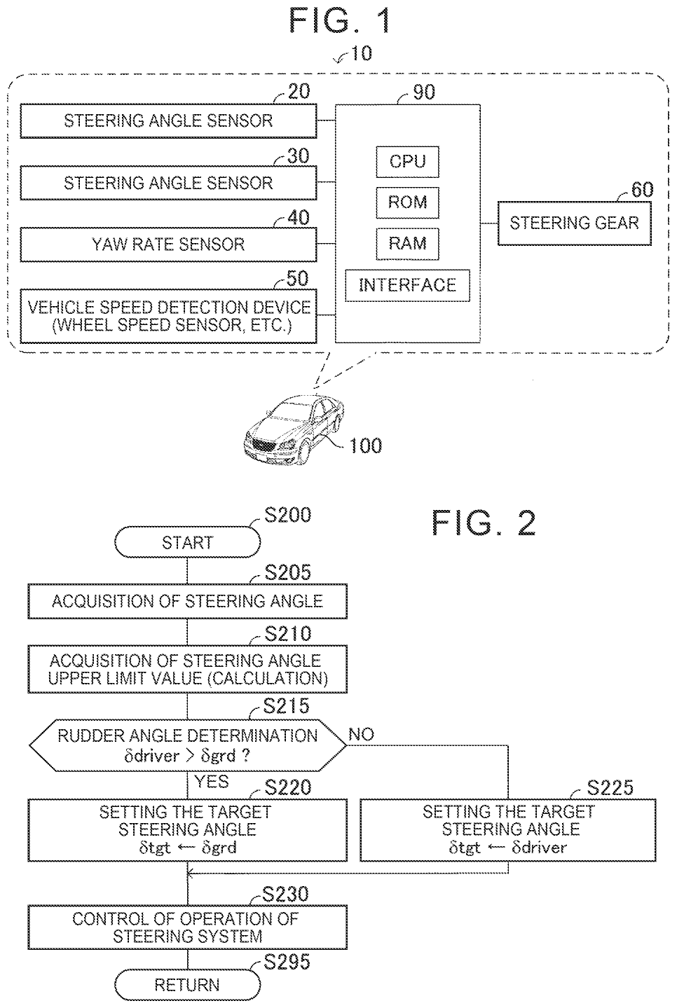

Hereinafter, a vehicle control device according to an embodiment of the present disclosure will be described with reference to the drawings. FIG. 1 shows a vehicle control device 10. The vehicle control device 10 is mounted on the target vehicle 100. Hereinafter, the vehicle control device 10 will be described by taking as an example a case where the operator of the target vehicle 100 is a person who rides on the target vehicle 100 and drives the target vehicle 100 (that is, the driver of the target vehicle 100).

However, the operator of the target vehicle 100 may be a person who drives the target vehicle 100 remotely without getting on the target vehicle 100 (that is, a remote operator of the target vehicle 100). When the operator of the target vehicle 100 is a remote operator, the vehicle control device 10 may be mounted on the target vehicle 100 and a remote control facility installed outside the target vehicle 100 for remotely driving the target vehicle 100. In this case, the functions of the vehicle control device 10 described below are shared by the vehicle control device 10 mounted on the target vehicle 100 and the vehicle control device 10 mounted on the remote control facility.

The vehicle control device 10 is also applicable to an autonomous vehicle (a vehicle in which the target vehicle 100 is automatically driven).

As illustrated in FIG. 1, the vehicle control device 10 includes an electronic control device (ECU) 90 as a control device. ECU 90 includes a microcomputer as a main part. The microcomputer includes a storage medium such as a CPU, ROM, RAM and a non-volatile memory, an interface, and the like. CPU implements various functions by executing instructions, programs, or routines stored in a storage medium. In particular, in the present example, the vehicle control device 10 stores, in a storage medium, a vehicle driving support program for executing steering control, which will be described later.

Note that the vehicle control device 10 may be configured to be able to update the vehicle driving support program by wireless communication (for example, Internet communication) with an external device.

The vehicle control device 10 controls the steering of the target vehicle 100 by executing the routine shown in FIG. 2 at a predetermined calculation cycle. Accordingly, the vehicle control device 10 starts the process from S200 of the routine illustrated in FIG. 2. The vehicle control device 10 advances the process to S205 and acquires the steering angle θ of the target vehicle 100.

As illustrated in FIG. 1, the vehicle control device 10 includes a steering angle sensor 20. The steering angle sensor 20 is a sensor that detects a rotation angle of the steering shaft of the target vehicle 100. The rotation angle of the steering shaft is an angle at which the steering shaft rotates from a neutral position of the steering shaft. The steering angle sensor 20 is electrically connected to ECU 90. ECU 90 (that is, the vehicle control device 10) acquires, as the steering angle θ, an angle at which the steering shaft is rotated from its neutral position by the steering angle sensor 20. ECU 90 acquires the steering angle of the target vehicle 100 requested by the driver as the driver-requested steering angle δdriver based on the steering angle θ.

Next, the vehicle control device 10 advances the process to S210, and obtains (sets) the steering angle upper limit value δgrd by calculation. The steering angle upper limit value δgrd is for limiting the target value (target steering angle δtgt) of the steering angle of the target vehicle 100, and a calculation method thereof will be described later.

Next, the vehicle control device 10 advances the process to S215, and determines whether or not the driver-requested steering angle δdriver is larger than the steering angle upper limit value δgrd.

When the vehicle control device 10 determines “Yes” in S215, the vehicle control device 10 advances the process to S220 and sets the steering angle upper limit value δgrd as the target steering angle δtgt. The vehicle control device 10 then advances the process to S230. That is, the vehicle control device 10 limits the target steering angle δtgt to the steering angle upper limit value δgrd.

As illustrated in FIG. 1, the vehicle control device 10 includes a steering device 60. The steering device 60 is a device that controls the steering angle of the target vehicle 100, and is electrically connected to ECU 90. ECU 90 (that is, the vehicle control device 10) can control the steering angle of the target vehicle 100 by controlling the operation of the steering device 60.

When the process proceeds to S230, the vehicle control device 10 controls the operation of the steering device 60 so that the steering angle of the target vehicle 100 becomes the target steering angle δtgt set by S220. After that, the vehicle control device 10 advances the processing to S295, and ends the processing of the routine once.

As illustrated in FIG. 1, the vehicle control device 10 includes a steering angle sensor 30. The steering angle sensor 30 is a sensor that detects a steering angle of the target vehicle 100, and is electrically connected to ECU 90. ECU 90 (that is, the vehicle control device 10) acquires the steering angle of the target vehicle 100 as the control steering angle δcur by the steering angle sensor 30. The vehicle control device 10 controls the operation of the steering device 60 so that the control steering angle δcur coincides with the target steering angle ôtgt.

On the other hand, when the vehicle control device 10 determines “No” in S215, the vehicle control device 10 advances the process to S225 and sets the present driver-requested steering angle δdriver as the target steering angle δtgt. Next, the vehicle control device 10 advances the process to S230, and controls the operation of the steering device 60 so that the control steering angle δcur of the target vehicle 100 becomes the target steering angle δtgt set by S225. After that, the vehicle control device 10 advances the processing to S295, and ends the processing of the routine once.

Thus, the steering angle of the target vehicle 100 is limited to be equal to or less than the steering angle upper limit value δgrd, that is, the lateral acceleration of the target vehicle 100 is limited to be equal to or less than a certain value, and the steering of the target vehicle 100 is controlled.

Next, a method of calculating the steering angle upper limit value δgrd will be described.

When the driver-requested steering angle δdriver is large enough to generate the sideslip of the target vehicle 100, it is preferable that the driver-requested steering angle δdriver is not set to the target steering angle δtgt as it is, but is set to the target steering angle δtgt that does not generate the sideslip of the target vehicle 100. That is, the target steering angle δtgt is preferably set so that the lateral acceleration of the target vehicle 100 is limited to a certain value or less. Therefore, the vehicle control device 10 sets the steering angle upper limit value δgrd in the following manner, and limits the target steering angle δtgt to the steering angle upper limit value δgrd.

The vehicle control device 10 acquires the steering angle difference Δδ by calculation based on the following Expression 1 using the yaw rate w, the target vehicle speed V, the lateral acceleration upper limit Ggrd, the stability factor A, the wheel base L of the target vehicle 100, and the gear ratio N of the target vehicle 100. Then, the vehicle control device 10 acquires the steering angle upper limit value δgrd by adding the steering angle difference Δδ to the current control steering angle δcur, as shown in Expression 2 below.

$$\begin{matrix}Δδ = ( 1 + A \cdot {V}^{2} ) \cdot ( L \cdot N / {V}^{2} ) \cdot ( Grgd - V \cdot ω ) & ( 1 ) \\ δ grd = δ cur + Δδ & ( 2 )\end{matrix}$$

The lateral acceleration upper limit value Ggrd is a predetermined value (predetermined lateral acceleration) and is an upper limit of a value allowed as the lateral acceleration of the target vehicle 100. The stability factor A, the wheel base L, and the gear ratio N are also default values, respectively. In this example, when the true value of the stability factor A is unknown, it is preferable to set the stability factor A to a value smaller than the actual stability factor of the target vehicle 100 even if the target vehicle 100 is any type of vehicle (vehicle type).

As illustrated in FIG. 1, the vehicle control device 10 includes a yaw rate sensor 40 and a vehicle speed detection device 50. The yaw rate sensor 40 is a sensor that detects the yaw rate of the target vehicle 100 and is electrically connected to ECU 90. ECU 90 (that is, the vehicle control device 10) acquires the yaw rate of the target vehicle 100 as the yaw rate w by the yaw rate sensor 40. The vehicle speed detection device 50 is a sensor that detects the traveling speed of the target vehicle 100, and includes, for example, a wheel speed sensor. The vehicle speed detection device 50 is electrically connected to ECU 90. ECU 90 (that is, the vehicle control device 10) acquires the traveling speed of the target vehicle 100 as the target vehicle speed V by the vehicle speed detection device 50.

In Expression 1, the yaw rate w is a current yaw rate of the target vehicle 100 detected by the yaw rate sensor 40 and is a value indicating a traveling state of the target vehicle 100. In Expression 1, the target vehicle speed V is a detection value of the current traveling speed of the target vehicle 100 detected by the vehicle speed detection device 50, and is a value indicating the traveling state of the target vehicle 100.

In this example, the yaw rate ω (the detected value of the yaw rate of the target vehicle 100) and the target vehicle speed V (the detected value of the traveling speed of the target vehicle 100) are adopted as the traveling state of the target vehicle 100 used for acquiring the steering angle upper limit value δgrd. However, other detection values representing the traveling state of the target vehicle 100 (in particular, other detection values excluding the detection value of the lateral acceleration of the target vehicle 100) may be adopted as the traveling state of the target vehicle 100.

As described above, in order to limit the lateral acceleration of the vehicle to a certain value or less, the steering angle upper limit value may be set based on the specification value of the vehicle and the steering angle zero point of the vehicle (the steering angle that is known to allow the vehicle to travel straight). However, the specifications of the vehicle vary depending on the vehicle. In addition, the steering angle zero point of the vehicle may deviate from the true steering angle zero point. Therefore, the steering angle upper limit value set based on the specification value of the vehicle and the steering angle zero point of the vehicle may be inappropriate for limiting the lateral acceleration of the vehicle to a certain value or less.

According to the vehicle control device 10, the steering angle upper limit value δgrd is set based on the yaw rate ω and the target vehicle speed V without using the lateral acceleration of the target vehicle 100. Here, the yaw rate ω is a value that changes in accordance with the steering angle of the target vehicle 100 and correlates with the lateral acceleration of the target vehicle 100. Further, the target vehicle speed V is a value that affects the lateral acceleration of the target vehicle 100. Therefore, by setting the target steering angle δtgt so that the steering angle (control steering angle δcur) of the target vehicle 100 is limited to be equal to or less than the steering angle upper limit value δgrd, the lateral acceleration of the target vehicle 100 can be appropriately limited to be equal to or less than a constant value. The reason for this will be described below.

When the estimated value of the current steering angle of the target vehicle 100 is the estimated steering angle δcur_cal, the estimated steering angle δcur_cal can be expressed by the following Expression 3. In Expression 3, “Gcur” is the present lateral acceleration of the target vehicle 100, and “δ₀” is the steering angle (steering angle zero point) that is grasped to cause the target vehicle 100 to travel straight.

$$δcur\_cal = ( 1 + A \cdot {V}^{2} ) \cdot L \cdot ( Gcur / {V}^{2} ) \cdot N + {δ}_{0} \qquad ( 3 )$$

Further, the present lateral acceleration Gcur of the target vehicle 100 can be expressed by Expression 4 below.

$$Gcur = V \cdot ω \qquad ( 4 )$$

Therefore, from Expressions 3 and 4, the estimated steering angle δcur_cal can be expressed by Expression 5 below.

$$δcur\_cal = ( 1 + A \cdot {V}^{2} ) \cdot L \cdot ( V \cdot ω / {V}^{2} ) \cdot N + {δ}_{0} \qquad ( 5 )$$

On the other hand, when the theoretical value of the steering angle upper limit value corresponding to the lateral acceleration upper limit value Ggrd is defined as the theoretical steering angle upper limit value δgrd_cal, the theoretical steering angle upper limit value δgrd_cal can be expressed by the following Expression 6.

$$δcur\_cal = ( 1 + A \cdot {V}^{2} ) \cdot L \cdot ( Ggrd / {V}^{2} ) \cdot N + {δ}_{0} \qquad ( 6 )$$

Here, since the steering angle difference Δδ is expressed by the following Expression 7, the following Expression 8 is derived from Expression 3, Expression 6 and Expression 7. That is, the steering angle difference Δδ is obtained by the calculation according to the following Expression 8.

$$\begin{matrix}Δδ = δgrd\_cal - δcur\_cal & ( 7 ) \\ Δδ = ( 1 + A \cdot {V}^{2} ) \cdot ( L \cdot N / {V}^{2} ) \cdot ( Ggrd - Gcur ) & ( 8 )\end{matrix}$$

Then, as described above, the following Expression 9 holds between the present lateral acceleration Gcur of the target vehicle 100, the target vehicle speed V, and the yaw rate ω, and therefore, the following Expression 10 is derived from Expressions 8 and 9. That is, Expression 1 above is derived.

$$\begin{matrix}Gcur = V \cdot ω & ( 9 ) \\ Δδ = ( 1 + A \cdot {V}^{2} ) \cdot ( L \cdot N / {V}^{2} ) \cdot ( Ggrd - V \cdot ω ) & ( 10 )\end{matrix}$$

Here, as described above, in the present example, when the true value of the stability factor A is unknown, it is preferable to set the stability factor A to a value smaller than the actual stability factor A of the target vehicle 100 even if the target vehicle 100 is a vehicle of any type (vehicle type). Then, the theoretical steering angle upper limit value δgrd_cal deviates from the steering angle upper limit value corresponding to the lateral acceleration upper limit value Ggrd, but does not exceed the steering angle upper limit value. Further, the estimated steering angle δcur_cal is deviated from the current true steering angle of the target vehicle 100. However, the steering angle difference Δδ is a difference between the theoretical steering angle upper limit value δgrd_cal and the estimated steering angle δcur_cal. Therefore, irrespective of the value of the true steering angle zero point, the difference between the steering angle upper limit value corresponding to the true lateral acceleration upper limit value Ggrd and the present true steering angle of the target vehicle 100 substantially matches. Therefore, as shown in Expression 11 below, the steering angle upper limit value δgrd obtained by adding the steering angle difference Δδ to the control steering angle δcur substantially coincides with the steering angle upper limit value corresponding directly to the lateral acceleration upper limit value Ggrd, and does not exceed the steering angle upper limit value.

$$δ grd = δ cur + Δδ \qquad ( 11 )$$

In this example, as the stability factor A, when its true value is unknown, a value smaller than the actual stability factor A of the target vehicle 100 is adopted. Therefore, the steering angle difference Δδ is a value smaller than the true steering angle difference. Therefore, the steering angle upper limit value δgrd is a value smaller than the true steering angle upper limit value. However, the steering angle upper limit value δgrd is repeatedly calculated according to the present example, so that the steering angle upper limit value δgrd becomes a value close to the true steering angle upper limit value.

This is the reason why the appropriate steering angle upper limit value δgrd can be set by Expressions 1 and 2.

The present disclosure is not limited to the above embodiment, and various modifications can be adopted within the scope of the present disclosure.

What is claimed is:

1. A vehicle control device comprising a control device configured to control steering of a target vehicle, wherein the control device is configured to:
set, based on a traveling state of the target vehicle, a steering angle upper limit value that is an upper limit value of a steering angle of the target vehicle for restricting a lateral acceleration of the target vehicle to a predetermined lateral acceleration or less; and
control the steering of the target vehicle to bring the steering angle of the target vehicle to the steering angle upper limit value or less.

2. The vehicle control device according to claim 1, wherein the traveling state is a detected value of a yaw rate of the target vehicle and a detected value of a traveling speed of the target vehicle.

3. The vehicle control device according to claim 1, wherein the control device is configured to:
detect a yaw rate of the target vehicle and a traveling speed of the target vehicle as the traveling state; and
set the steering angle upper limit value based on the yaw rate and the traveling speed without using the lateral acceleration of the target vehicle.

4. A vehicle control method that controls steering of a target vehicle, the vehicle control method comprising:
a step of setting, based on a traveling state of the target vehicle, a steering angle upper limit value that is an upper limit value of a steering angle of the target vehicle for restricting a lateral acceleration of the target vehicle to a predetermined lateral acceleration or less; and
a step of controlling the steering of the target vehicle to bring the steering angle of the target vehicle to the steering angle upper limit value or less.

5. A non-transitory storage medium storing a vehicle control program that controls steering of a target vehicle, the vehicle control program being configured to:
set, based on a traveling state of the target vehicle, a steering angle upper limit value that is an upper limit value of a steering angle of the target vehicle for restricting a lateral acceleration of the target vehicle to a predetermined lateral acceleration or less; and
control the steering of the target vehicle to bring the steering angle of the target vehicle to the steering angle upper limit value or less.
